(19) United States
(12) Patent Application Publication
(10) Pub. No.: US 2007/0186234 A1
(43) Pub. Date: Aug. 9, 2007

(54) System and method for a ratings-based electronic guide

(76) Inventors: Christopher Cormack, Hillsboro, OR (US); Tony Moy, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/351,355

(22) Filed: Feb. 9, 2006

(51) Int. Cl. H04N 5/445; G06F 13/00; G06F 3/00; H04N 7/16

(52) U.S. Cl. 725/28; 725/45; 725/46

(57) ABSTRACT

A system and method for a ratings-based electronic guide. One method includes generating a ratings-based electronic guide based on content, related guide data and a content ratings list, where the content ratings list may include the ratings of the content for one or more of a specified location and a specified timeframe.

### BACKGROUND

Standard electronic program guides (EPGs) provide a program listing based on the channel, for given time slots. This is typically a huge list that the viewer must manually search through to find his or her favorite programs. Finding specific programs can be quite difficult as the viewer must scroll down and to the right of the EPG for long periods of time and often through multiple screens of information.

### BRIEF DESCRIPTION OF THE DRAWINGS

The invention may be best understood by referring to the following description and accompanying drawings that are used to illustrate embodiments of the invention. In the drawings:

FIG. 1 illustrates an example of a standard electronic program guide (EPG);

FIG. 2 illustrates an example of a content ratings list, according to an embodiment of the invention;

FIG. 3 illustrates an example of a ratings-based electronic guide, according to an embodiment of the invention;

FIG. 4 illustrates an embodiment of an environment for the ratings-based electronic guide, in which some embodiments of the present invention may operate;

FIG. 5 illustrates an embodiment of an environment for the ratings-based electronic guide, in which some embodiments of the present invention may operate; and

FIG. 6 is a flow diagram of one embodiment of a process for the operation of generating a ratings-based electronic guide, in which some embodiments of the present invention may operate.

### DESCRIPTION OF EMBODIMENTS

According to an embodiment of the invention, a system and method for a ratings-based electronic guide are described. In some embodiments of the invention, the ratings-based electronic guide may reflect content as it was rated by the people of a specified location and/or for a specified timeframe. Example specified locations may include, but are not limited to, the Jones household, the city of Portland, the state of Oregon, all of America, and so forth. Example specified timeframes may include, but are not limited to, what is popular today, what was popular in year 2005, what was popular last week, and so forth. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

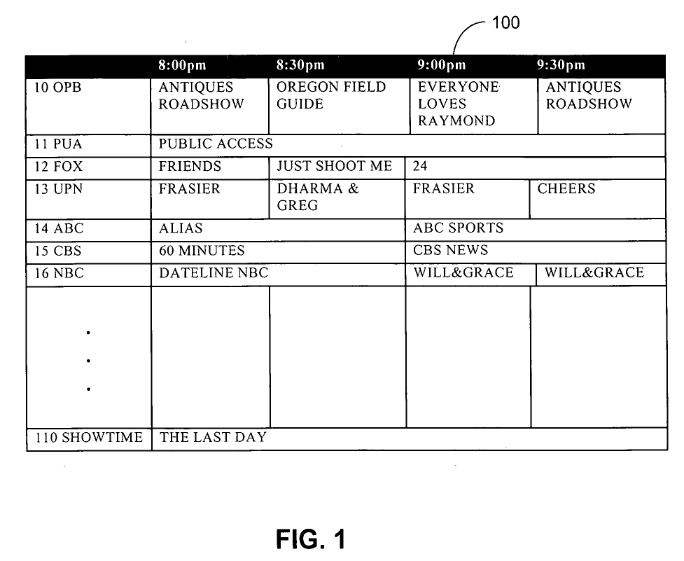

FIG. 1 illustrates an example of a standard electronic program guide (EPG) 100. Referring to FIG. 1, the standard EPG is broadcast channel oriented, for given time slots. This is typically a huge list that the viewer must manually search through to find his or her favorite shows. Finding specific shows can be quite difficult as the viewer must scroll down and to the right of the EPG for long periods of time and often through multiple screens of information to search for shows.

In contrast to a standard EPG, the ratings-based electronic guide of the present invention helps a viewer to easily determine how to access the top rated content for a specified location and/or timeframe. In an embodiment of the invention, content may include, but is not limited to, shows or programs, voice, audio, music, graphics, video games, books, and so forth. The content may be broadcasted, pre-recorded and stored on a digital recording device (such as a personal video recorder (PVR)), streamed or downloaded via the Internet, stored on a home local area network (LAN) (such as in a networked home entertainment system), and so forth.

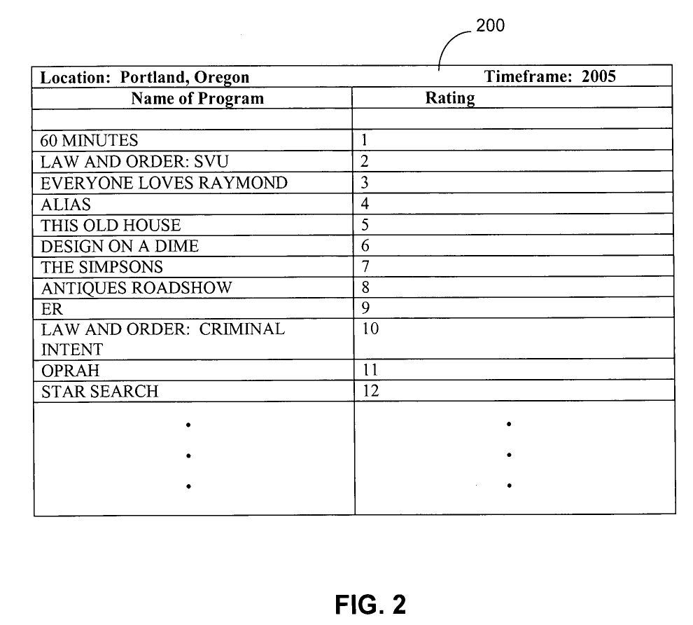

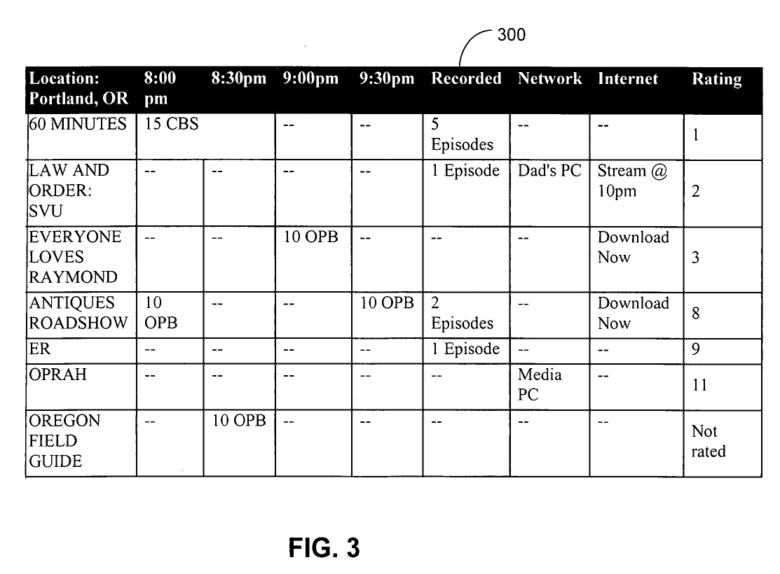

In an embodiment of the invention, a viewer may optionally provide the present invention with a specified location and/or timeframe. The present invention may access ratings data for content and generate a content ratings list based on the specified location and/or timeframe. Ratings data may be obtained from Nielsen Media Research, Arbitron Ratings, an entertainment web site, a cable/satellite television provider, a household, one or more viewers, and so forth. Ratings data may reflect content that was viewed, downloaded and/or recorded. The content ratings list may then be compared to the content currently available to the viewer to generate a ratings-based electronic guide. An example content ratings list is illustrated next with reference to FIG. 2. An example ratings-based electronic guide is illustrated below with reference to FIG. 3.

FIG. 2 illustrates an example content ratings list 200, according to an embodiment of the invention. As described above, the content ratings list may reflect the top rated content viewed/downloaded/recorded based on a specified location and/or timeframe. In an embodiment of the invention, the content is listed in order of popularity. A user interface or remote control button may be utilized by a viewer to specify the desired location and/or timeframe. The user interface or remote control button may also be utilized by the viewer to provide ratings data.

In the example content ratings list in FIG. 2, the specified location is Portland, Oreg. and the timeframe is the year 2005. Referring to FIG. 2, “60 MINUTES” was rated number 1 in Portland, Oreg. in 2005; “LAW AND ORDER: SVU” was rated number 2 in Portland, Oreg. in 2005; and so forth. The content ratings list illustrated in FIG. 2 is provided for illustration purposes only and is not meant to limit the invention.

FIG. 3 illustrates an example ratings-based electronic guide 300, according to an embodiment of the invention. Referring to FIG. 3, the example content ratings list from FIG. 2 was used to generate the electronic guide illustrated in FIG. 3. The ratings-based electronic guide lists Portland, Oreg.'s top rated content in 2005 that is currently available to the viewer. The ratings-based electronic guide of FIG. 3 also provides an indication on how the content is available (e.g., scheduled to be broadcasted, pre-recorded and stored on a digital recording device, available for streaming or downloading via the Internet, stored on a home local area network (LAN), and so forth). In an embodiment of the invention, the content is listed in order of popularity.

Referring to the ratings-based electronic guide of FIG. 3, a viewer can easily determine that the number 1 rated content in Portland, Oreg. for 2005 was “60 MINUTES” and it is being broadcasted on CBS at 8:00 pm and is also available via previously recorded episodes. The next most top rated content that is currently available to the viewer is “LAW AND ORDER: SVU”. “LAW AND ORDER: SVU” was rated number 2 and is available via previously recorded episodes, via the network and via streaming at 10 PM. Other content currently available for viewing include “EVERYONE LOVES RAYMOND”, “ANTIQUES ROADSHOW”, “ER”, “OPRAH” and “OREGON FIELD GUIDE”.

The electronic guide of FIG. 3 may be utilized by a viewer to select what content to watch, listen to, play, record, download, etc. The example electronic guide of FIG. 3 is provided for illustration purposes only and is not meant to limit the invention.

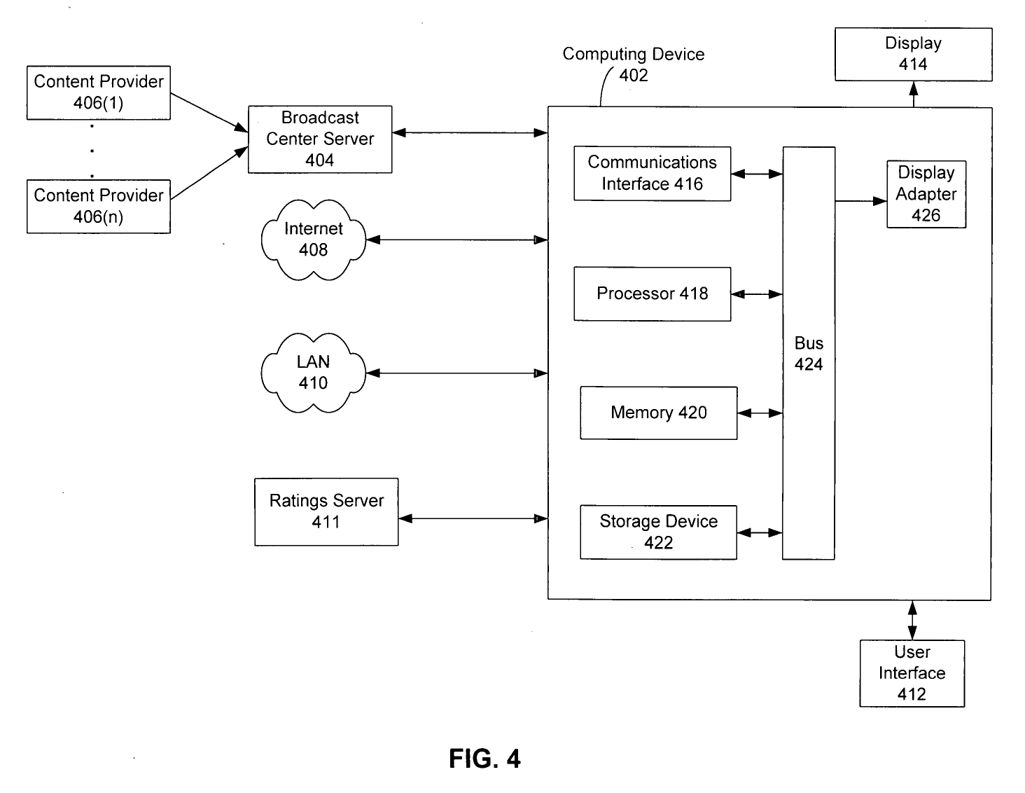

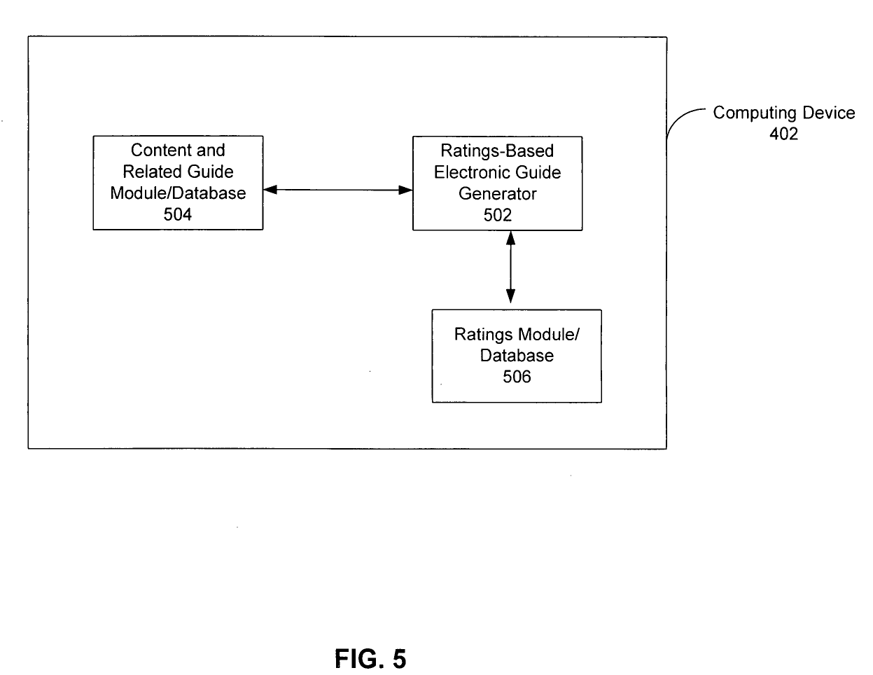

FIGS. 4 and 5 each illustrate an embodiment of an environment for the ratings-based electronic guide, in which some embodiments of the present invention may operate. The specific components shown in each of FIGS. 4 and 5 represent one example of a configuration that may be suitable for the invention and is not meant to limit the invention. Thus, other embodiments of the invention may include more or less components as described in each of FIGS. 4 and 5. For example, the functionality of two or more components of FIG. 4 or 5 may be combined into one component. Likewise, the functionality of one component of FIG. 4 or 5 may be separated and performed by more than one component. Each component shown in FIG. 4 or 5 may be implemented as a hardware element, as a software element executed by a processor, as a silicon chip encoded to perform its functionality described herein, or any combination thereof.

The environments of each of FIGS. 4 and 5 may be implemented as a wired communication system, a wireless communication system, or a combination of both. Although the environment of each of FIGS. 4 and 5 may be illustrated using a particular communications medium by way of example, it may be appreciated that the principles and techniques discussed herein may be implemented using any type of communication media and accompanying technology. The embodiments are not limited in this context. Other communication systems may be added or substituted according to the particular application for the environment in FIGS. 4 and 5 and/or as new types of systems are developed.

Referring to FIG. 4, the environment may include, but is not necessarily limited to, a computing device 402, a broadcast center server 404, one or more content providers 406(1)-406(n), the Internet 408, a local area network (LAN) 410, a ratings server 411, a user interface 412 and a display 414. Computing device 402 may include, but is not necessarily limited to, a communications interface 416, a processor 418, memory 420, a storage device 422, a bus 424 and a display adapter 426. At a high level and in an embodiment of the invention, computing device 402 may receive content and related guide data for a ratings-based electronic guide from broadcast center server 404, the Internet 408, LAN 410 and from content stored on computing device 402 itself. Computing device 402 may receive ratings data from ratings server 411. Computing device 402 may also receive input via user interface 412 from one or more viewers regarding the rating of content, activation and/or reconfiguration of the ratings-based electronic guide, and so forth. The ratings-based electronic guide may be displayed on display 414.

In an embodiment of the invention, content may include, but is not necessarily limited to, shows or programs, voice, audio, music, graphics, video games, books, and so forth. In an embodiment of the invention, related guide data may include, but is not necessarily limited to, content name, channel or location (e.g., location on the Internet 408 via an Internet Protocol (IP) address or Uniform Resource Location (URL), location on a hard disk found in LAN 410, location on computing device 402 itself, etc.), type of content (e.g., broadcast, stream, download, etc.), metadata (e.g., content description, year of release, ratings information, category, etc.), air time, a brief synopsis, stars, and so forth. These examples are not meant to limit the invention. Each of the components of FIG. 4 is described next in more detail.

Computing device 402 may be any device adapted to include the functionality of the present invention. For example, device 402 may be a set-top box, a digital video recorder, a digital network recorder, a personal computer, a portable computer, a cellular telephone, a personal digital assistant (PDA), a computing tablet, or any other similar device. Although only one computing device 402 is depicted in FIG. 4, the invention may involve multiple computing devices 402.

In an embodiment of the invention, computing device 402 may include communications interface 416 that allows for the receipt of high-speed digital data such as a cable modem, DSL modem, Ethernet interface, satellite receiver, etc. Computing device 402 may also include a non-volatile storage device 422 for storing received digital data for later access. Such storage devices typically include magnetic media such as hard disk drives and may include other machine readable media such as optical disks, card and stick memory devices, flash memory devices, and the like.

In one embodiment, the invention is included in computing device 402 as software that is stored on storage device 422 or other machine readable medium and is executed by processor 418 which utilizes memory 420. Processor 418 may be any processor, and memory 420 may be any kind of random access memory (RAM) or other form of memory.

Computing device 402 may process received content and related guide data and ratings data to create a ratings-based electronic guide and sends a resulting signal via display adapter 426 to display 414 to be presented to a viewer. Communications interface 416, processor 418, memory 420, storage device 422 and display adapter 426 are, in one embodiment, coupled to bus 424. In various embodiments, computing device 402 may include multiple communications interfaces, processors, storage devices, display adapters and buses, as well as other components not shown in FIG. 4. In various embodiments, computing device 402 may include an audio processor and/or game processor or game interface.

In an embodiment of the invention, computing device 402 may receive content and related guide data for a ratings-based electronic guide from broadcast center server 404, the Internet 408 and LAN 410. This may be a straight download of all content and related guide data or may be a query to limit the amount of information received by computing device 402. Content and related guide data used for the ratings-based electronic guide may also be recorded on computing device 402 itself (e.g., in storage device 422). Broadcast center server 404 may receive data from at least one content provider 406 and forwards digital data to computing device 402. Content providers 406 may be a server computer or a group, subnetwork, LAN or other group of multiple computers, that provide data to broadcast center server 404.

The Internet 408 may be used by computing device 402 for streamed content and related guide data (such as via subscription services) and for downloadable content and related guide data (such as video/audio from an Internet-based store that allows a user to purchase video/audio). LAN 410 may be a household, office, or store media server or personal computers that contain content, such as, for example, television programs and audio files.

Ratings server 411 may be used by computing device 402 for ratings data of content. This may be a straight download of all ratings data or may be a query to limit the amount of information received by computing device 402. As described above, ratings data may be obtained from Nielsen Media Research, Arbitron Ratings, an entertainment web site, a cable/satellite television provider, a household, one or more viewers, and so forth. Ratings data may reflect content that was viewed, downloaded and/or recorded.

In embodiments of the invention, connections between content providers 406, broadcast center server 404, the Internet 408, LAN 410, ratings server 411 and computing device 402 may be one or more of T1 lines, T3 lines, coaxial cable, Ethernet, twisted-pair, fiber optics such as a Synchronous Optical Network (SONET), digital television (DTV), cable television (CATV), microwave, satellite, radio waves, or any combination of wired/wireless communications.

In an embodiment of the invention, broadcast center server 404, the Internet 408 and LAN 410 may receive content as digital data or analog data. If analog data is received, it may be converted into an appropriate digital format before being forwarded to computing device 402. When content is received as analog data, it may be any well-known or proprietary analog format, such as the National Television System Committee (NTSC) format.

The format of the content sent to computer device 402 may be any digital data format, including, for example, data interchange formats such as Internet Protocol (IP) Packets and File Transfer Protocol (FTP) packets; combined audio and moving video formats such as the formats promulgated by the International Telecommunications Union (ITU), the Advanced Television Systems Committee (ATSC), and similar organizations such as High Definition Television (HDTV) and Moving Pictures Expert Group (MPEG); related audio formats; still video formats such as Joint Photographic Experts Group (JPEG) format, Graphic Interchange Format (GIF); and so forth.

In an embodiment of the invention, the ratings-based electronic guide may be displayed on display 414. Display 414 may be external to computing device 402 or may be incorporated into device 402. Display 414 may be a cathode ray tube (CRT) display monitor, a thin film transistor (TFT) display screen, a liquid crystal display (LCD), or any display device suitable for displaying graphics and images.

User interface 412 may be any device capable of allowing one or more viewers to interface with computing device 402. User interface 412 may be external to computing device 402 or may be incorporated into device 402. For example, user interface 412 may be utilized by one or more viewers to log into computing device 402, to activate the ratings-based electronic guide, to configure the ratings-based electronic guide, to provide content ratings data, and so forth. In embodiments of the invention, user interface 412 may be implemented as a remote control, a PDA, a touch screen or button(s) on the display 414 or computing device 402, a joystick, a keyboard, a game pad, a personal computer, a laptop computer, a cellular phone, and so forth. These examples are provided for illustration purposes only and are not meant to limit the invention.

FIG. 5 illustrates an embodiment of an environment for the ratings-based electronic guide, in which some embodiments of the present invention may operate. Referring to FIG. 5, computing device 402 may include a ratings-based electronic guide generator 502, a content and related guide module/database 504 and a ratings module/database 506. Each of these components may be implemented via software, firmware, hardware, or by any combination of various techniques. Each of these components is described next in more detail.

Content and related guide module/database 504 stores, aggregates and indexes the content and related guide data received via broadcast center server 404, the Internet 408, LAN 410 and recorded on computing device 402 itself. This may be a straight download of all content and related guide data or may be a query to limit the amount of information received by computing device 402.

In an embodiment of the invention, ratings module/database 506 compiles and stores one or more content ratings lists. Based on the specified location and/or timeframe provided by the viewer, ratings module/database 506 examines ratings data for content and generates a content ratings list. In an embodiment of the invention, the content ratings list is specific to the viewer specified location and/or timeframe. In an embodiment of the invention, if the viewer does not provide a location and/or timeframe, then ratings module/database 506 may generate a default content ratings list. The default content ratings list may include any default location and/or timeframe.

Ratings-based electronic guide generator 502 examines the content and/or related guide data from module/database 504 and a content ratings list from module/database 506 and generates a ratings-based electronic guide.

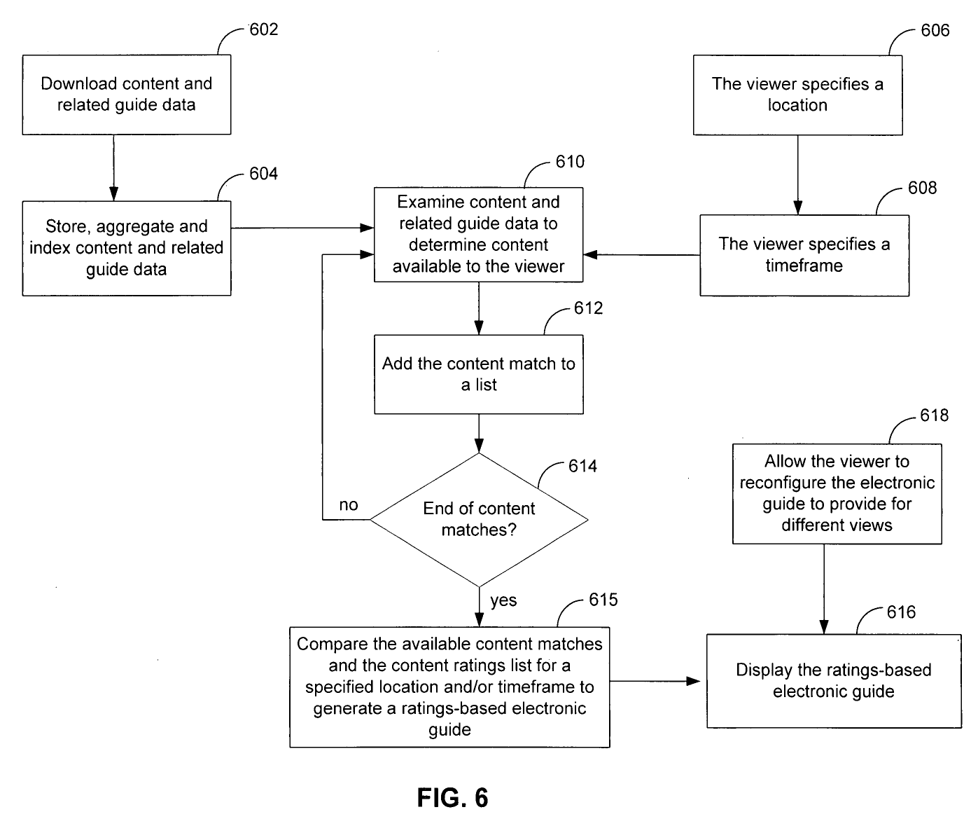

Embodiments of the operation of the present invention are described next with reference to FIG. 6. The flow diagram and other descriptions of processes herein are not intended to imply a fixed order of performing the process stages. Rather, the process stages may be performed in any order that is practicable.

FIG. 6 is a flow diagram of one embodiment of a process for the operation of generating a ratings-based electronic guide, in which some embodiments of the present invention may operate. Referring to FIG. 6, the process begins at block 602 where content and related guide data are downloaded to computing device 402. At block 604, the content and related guide data are stored, aggregated and indexed via content and related guide module/database 504.

A viewer may optionally select a location, at block 606. At block 608, the viewer may optionally select a timeframe.

The content and related guide data are examined for an available content match, at block 610. At block 612, the content match is added to a list. If there are additional content at block 614, then the content and related guide data are examined for another available content match, at block 610.

The available content matches and the content ratings list for a specified location and/or timeframe are compared to generate a ratings-based electronic guide, at block 615. At block 616, the ratings-based electronic guide is displayed. In an embodiment, the content of the electronic guide is sorted and displayed with the most popular content listed first.

At block 618, the viewer may interface with the ratings-based electronic guide to reconfigure it and provide a different view or format. For example, the viewer may want to switch the listings from most popular to alphabetically, to remove some content listings, to view the electronic guide as a standard EPG as described in FIG. 1, and so forth. These examples are not meant to limit the invention and are provided for illustration purposes.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc-Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
generating a ratings-based electronic guide based on content, related guide data and a content ratings list.

2. The method of claim 1, wherein the content ratings list includes ratings of the content for one or more of a specified location and a specified timeframe.

3. The method of claim 1, wherein the content may be rated via one or more of the content being viewed via its broadcast, streamed via the Internet and recorded via a device.

4. The method of claim 1, further comprising:
displaying the ratings-based electronic guide, wherein the displayed ratings-based electronic guide lists the top rated content first, the next most top rated content second, and so forth.

5. The method of claim 1, further comprising: receiving the content, the related guide data and ratings data at a device, wherein the device generates the content ratings list and the ratings-based electronic guide.

6. The method of claim 5, wherein the content and the related guide data may be received from one or more of a broadcast center server, the Internet, a local area network (LAN) and the device.

7. The method of claim 5, wherein the device is one of a set-top box and a digital television (DTV).

8. A system comprising:
a device to generate a ratings-based electronic guide based on content, related guide data and a content ratings list.

9. The system of claim 8, wherein the content ratings list includes ratings of the content for one or more of a specified location and a specified timeframe.

10. The system of claim 8, wherein the content may be rated via one or more of the content being viewed via its broadcast, streamed via the Internet and recorded via a device.

11. The system of claim 8, further comprising:
a display device to display the ratings-based electronic guide, wherein the displayed ratings-based electronic guide lists the top rated content first, the next most top rated content second, and so forth.

12. The system of claim 8, wherein the content and the related guide data may be received from one or more of a broadcast center server, the Internet, a local area network (LAN) and the device.

13. The system of claim 8, wherein the device is one of a set-top box and a digital television (DTV).

14. A machine-readable medium containing instructions which, when executed by a processing system, cause the processing system to perform a method, the method comprising:
generating a ratings-based electronic guide based on content, related guide data and a content ratings list.

15. The machine-readable medium of claim 14, wherein the content ratings list includes ratings of the content for one or more of a specified location and a specified timeframe.

16. The machine-readable medium of claim 14, wherein the content may be rated via one or more of the content being viewed via its broadcast, streamed via the Internet and recorded via a device.

17. The machine-readable medium of claim 14, further comprising:
displaying the ratings-based electronic guide, wherein the displayed ratings-based electronic guide lists the top rated content first, the next most top rated content second, and so forth.

18. The machine-readable medium of claim 14, further comprising: receiving the content, the related guide data and ratings data at a device, wherein the device generates the content ratings list and the ratings-based electronic guide.

19. The machine-readable medium of claim 18, wherein the content and the related guide data may be received from one or more of a broadcast center server, the Internet, a local area network (LAN) and the device.

20. The machine-readable medium of claim 18, wherein the device is one of a set-top box and a digital television (DTV).
